(19) United States
(12) Patent Application Publication
(10) Pub. No.: US 2022/0326451 A1
(43) Pub. Date: Oct. 13, 2022

(54) Waterproof T tap-type optical fiber connector

(71) Applicant: Shenzhen DYS Fiber Optic Technology Co., Ltd., Shenzhen, Guangdong (CN)

(72) Inventors: Roy Huang, Shenzhen, Guangdong (CN); Willen Wang, Shenzhen, Guangdong (CN); York Yu, Shenzhen, Guangdong (CN)

(21) Appl. No.: 17/056,675

(22) PCT Filed: Jan. 6, 2020
(86) PCT No.: PCT/CN2020/070408

§ 371 Date: Nov. 18, 2020

(30) Foreign Application Priority Data
Jan. 1, 2020 (CN) 202010000140.4

(51) Int. Cl. G02B 6/38

(52) U.S. Cl. CPC G02B 6/3849; G02B 6/389

(57) ABSTRACT

A waterproof optical fiber connector includes an SC-type connection member; a connection element including first external threads at a front end, rear second external threads, and a waterproof flange on an outer surface between the first external threads and the second external threads; an internally threaded waterproof inner shell put on the SC-type connection member and threadedly secured to the first external threads; a waterproof outer shell put on a portion of the waterproof inner shell and including external threads at a front end and threadedly secured to an internally threaded cap; and an internally threaded waterproof sleeve threadedly secured to the second external threads.

### BACKGROUND OF THE INVENTION

### 1. Field of the Invention

The invention relates to waterproof T tap-type optical fiber connector and more particularly to a waterproof T tap-type optical fiber connector.

### 2. Description of Related Art

An optical fiber is a flexible, transparent fiber made by drawing glass or plastic to a diameter slightly thicker than that of a human hair. Optical fibers are used most often as a means to transmit light between the two ends of the fiber and find wide usage in fiber-optic communications, where they permit transmission over longer distances and at higher bandwidths (data transfer rates) than electrical cables.

An optical fiber connector terminates the end of an optical fiber, and enables quicker connection and disconnection than splicing. The connectors mechanically couple and align the cores of fibers so light can pass. Better connectors lose very little light due to reflection or misalignment of the fibers.

A waterproof subscriber connector (SC)-type optical fiber connector is used in an outdoor environment. It has advantages including low wear, secure connection and excellent performance.

However, the waterproof SC-type optical fiber connector also has disadvantages including incapable of mounting a waterproof housing in a working site, high installation cost, and high manufacturing cost due to high precision requirements.

Thus, the need for improvement still exists.

### SUMMARY OF THE INVENTION

It is therefore one object of the invention to provide a waterproof optical fiber connector comprising an SC-type connection member; a connection element including first external threads at a front end, rear second external threads, and a waterproof flange on an outer surface between the first external threads and the second external threads; an internally threaded waterproof inner shell put on the SC-type connection member and threadedly secured to the first external threads; a waterproof outer shell put on a portion of the waterproof inner shell and including external threads at a front end and threadedly secured to an internally threaded cap; and an internally threaded waterproof sleeve threadedly secured to the second external threads.

Preferably, the waterproof inner shell includes a tubular member put on the SC-type connection member and a head and having a lengthwise groove on an inner surface of the head; the SC-type connection member includes a lengthwise projection on an outer surface; and the projection is disposed in the groove to secure the waterproof inner shell and the SC-type connection member together.

Preferably, the groove includes an inclined guide surface at a rear end. Preferably, the waterproof inner shell includes a sealing ring on an outer surface, the sealing ring urging against the flange. Preferably, further comprises a compression spring at a rear end of the waterproof sleeve.

Preferably, a bore of the SC-type connection member is in the range between 5mm and 6mm.

Preferably, the waterproof outer shell includes knurls on an outer surface. Preferably, further comprises a hollow cylindrical fastener urging onto a rear end of the SC-type connection member.

The above and other objects, features and advantages of the invention will become apparent from the following detailed description taken with the accompanying drawings.

### BRIEF DESCRIPTION OF THE DRAWINGS

FIG. 1 is ax exploded view of a waterproof T tap-type optical fiber connector according to the invention;

FIG. 2 is a perspective view of the waterproof inner shell; and

FIG. 3 is a perspective view of the assembled waterproof T tap-type optical fiber connector.

### DETAILED DESCRIPTION OF THE INVENTION

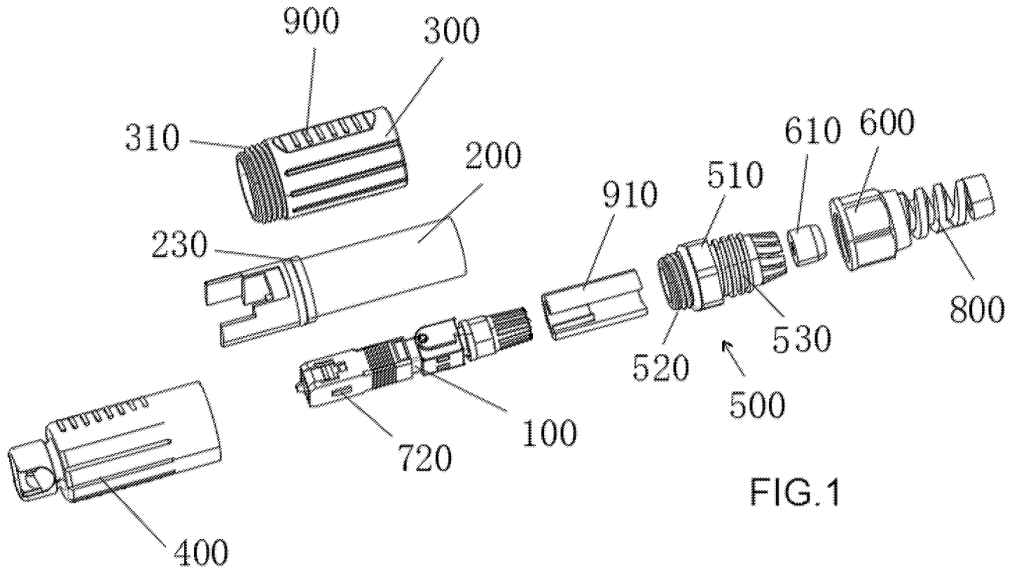

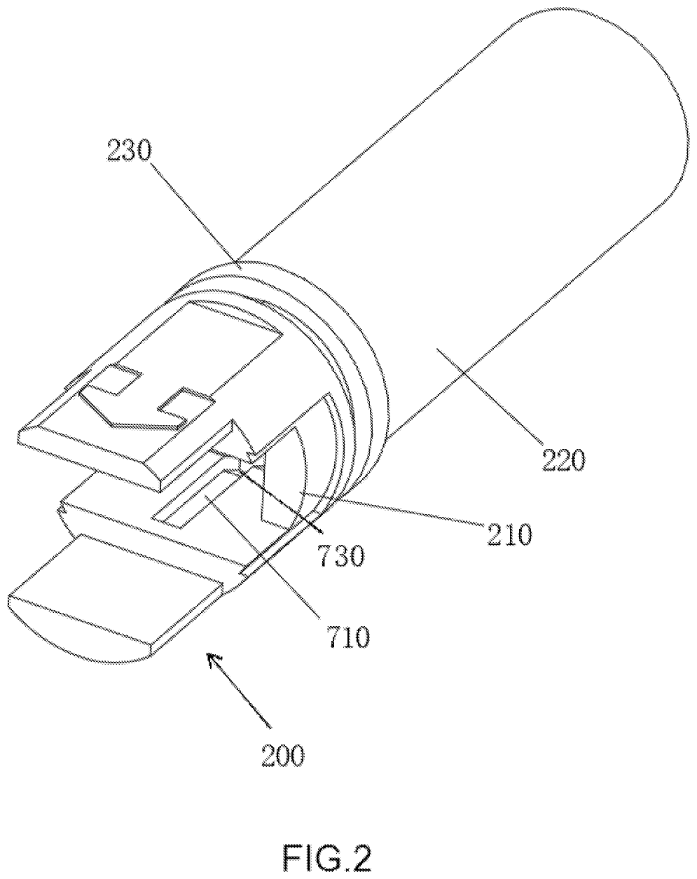

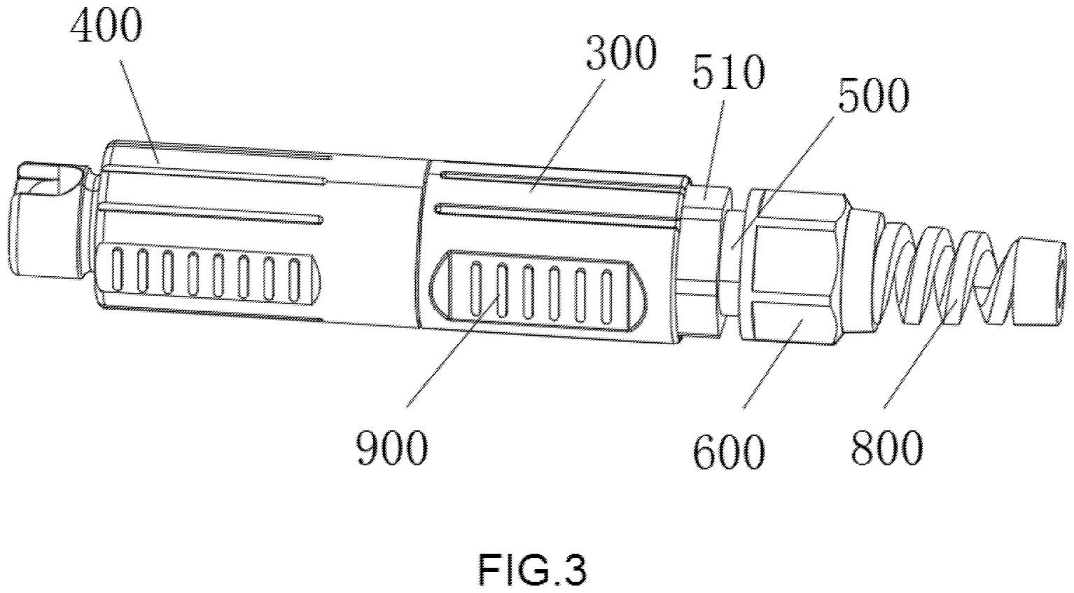

Referring to FIGS. 1 to 3, a waterproof T tap-type optical fiber connector in accordance with the invention comprises an SC-type connection member 100, an internally threaded waterproof inner shell 200 put on the SC-type connection member 100, and an internally threaded waterproof outer shell 300 put on the waterproof inner shell 200 as detailed below.

The SC-type connection member 100 includes an internally threaded cap 400 at a front end. The waterproof outer shell 300 includes external threads 310. The cap 400 is threadedly secured to the external threads 310. The SC-type connection member 100 further comprises a connection element 500 at a rear end. The connection element 500 includes external threads 520 at a front end. The external threads 520 are threadedly secured to the internal threads of the waterproof inner shell 200. The SC-type connection member 100 has a front end attached to an end of an optical fiber. The connection element 500 includes a waterproof flange 510 on an outer surface. An internally threaded waterproof sleeve 600 is threadedly secured to external threads 530 on an intermediate portion of the connection element 500. The waterproof sleeve 600 is secured to an insulating outer medium of optical fiber by glue or the like. A waterproof cap 610 is provided between the connection element 500 and the waterproof sleeve 600. The waterproof inner shell 200 is put on the SC-type connection member 100 and the waterproof outer shell 300 is put on the waterproof inner shell 200. The waterproof outer shell 300 is thus waterproofed due to the provisions of the cap 400 and the waterproof flange 510. It is noted the threaded connections of above components makes an assembly or disassembly easy.

The waterproof inner shell 200 includes a head 210 adjacent to the front end of the SC-type connection member 100, and a tubular member 220 put on the SC-type connection member 100. A lengthwise groove 710 is provided on an inner surface of the head 210. A lengthwise projection 720 is provided on an outer surface of the SC-type connection member 100. In assembly, the waterproof inner shell 200 is put on the SC-type connection member 100 from a rear end of the SC-type connection member 100 until the projection 720 passes through an inclined guide surface 730 at a rear end of the groove 710 and enters the groove 710 so as to secure the waterproof inner shell 200 and the SC-type connection member 100 together. A sealing ring 230 is provided on an outer surface of the waterproof inner shell 200 and has an outer diameter substantially equal to an inner diameter of the waterproof outer shell 300. In assembly, the waterproof outer shell 300 is put on the waterproof inner shell 200 from a front end of the waterproof inner shell 200 until the rear end of the waterproof outer shell 300 contacts the waterproof flange 510 and is stopped by the waterproof flange 510. The sealing ring 230 thus seals any gaps between the waterproof outer shell 300 and the waterproof inner shell 200 for waterproof purpose. Knurls 900 are provided on the outer surface of the waterproof outer shell 300 for aiding grip of the waterproof outer shell 300 by the hand. A compression spring 800 is provided at a rear end of the waterproof sleeve 600 for absorbing and damping shock impulses. The bore of the SC-type connection member 100 is in the range between 5 mm and 6 mm. In the embodiment, the bore of the SC-type connection member 100 is 5 mm. The SC-type connection member 100 is well known in the art and thus a detailed description thereof is omitted herein for the sake of brevity. The optical fiber is inserted through a rear end of the SC-type connection member 100 and fastened in the SC-type connection member 100 by urging a hollow cylindrical fastener 910 onto the rear end of the SC-type connection member 100.

An assembly of the invention is discussed below. The SC-type connection member 100 is secured to an end of the optical fiber. The waterproof sleeve 600 is put on the end of the optical fiber end of the optical fiber. The connection element 500 is put on the SC-type connection member 100 from the front end of the SC-type connection member 100 and threadedly secured to the waterproof sleeve 600. The waterproof inner shell 200 is put on the SC-type connection member 100 from the front end of the SC-type connection member 100 and threadedly secured to the front end of the connection element 500. The waterproof outer shell 300 is put on the waterproof inner shell 200 from the front end of the SC-type connection member 100 until the rear end of the waterproof outer shell 300 contacts the waterproof flange 510 and is stopped by the waterproof flange 510. The sealing ring 230 is at the front end of the waterproof outer shell 300. Finally, the cap 400 is threadedly secured to the external threads 310 of the waterproof outer shell 300. As an end, the waterproof T tap-type optical fiber connector is assembled.

While the invention has been described in terms of preferred embodiments, those skilled in the art will recognize that the invention can be practiced with modifications within the spirit and scope of the appended claims.

What is claimed is:

1. A waterproof optical fiber connector comprising:
an SC-type connection member;
a connection element including first external threads at a front end, rear second external threads, and a waterproof flange on an outer surface between the first external threads and the second external threads;
an internally threaded waterproof inner shell put on the SC-type connection member and threadedly secured to the first external threads;
a waterproof outer shell put on a portion of the waterproof inner shell and including external threads at a front end and threadedly secured to an internally threaded cap; and
an internally threaded waterproof sleeve threadedly secured to the second external threads.

2. The waterproof optical fiber connector of claim 1, wherein the waterproof inner shell includes a tubular member put on the SC-type connection member and a head and having a lengthwise groove on an inner surface of the head; wherein the SC-type connection member includes a lengthwise projection on an outer surface; and wherein the projection is disposed in the groove to secure the waterproof inner shell and the SC-type connection member together.

3. The waterproof optical fiber connector of claim 2, wherein the groove includes an inclined guide surface at a rear end.

4. The waterproof optical fiber connector of claim 1, wherein the waterproof inner shell includes a sealing ring on an outer surface, the sealing ring urging against the flange.

5. The waterproof optical fiber connector of claim 1, further comprising a compression spring at a rear end of the waterproof sleeve.

6. The waterproof optical fiber connector of claim 1, wherein a bore of the SC-type connection member is in the range between 5 mm and 6 mm.

7. The waterproof optical fiber connector of claim 1, wherein the waterproof outer shell includes knurls on an outer surface.

8. The waterproof optical fiber connector of claim 1, further comprising a hollow cylindrical fastener urging onto a rear end of the SC-type connection member.
